(19) United States
(12) Patent Application Publication
(10) Pub. No.: US 2018/0363532 A1
(43) Pub. Date: Dec. 20, 2018

(54) EXHAUST GAS SYSTEM

(71) Applicant: GM GLOBAL TECHNOLOGY OPERATIONS LLC, Detroit, MI (US)

(72) Inventors: Anil Yadav, Bangalore (IN); Prashant Kumar Mishra, Bangalore (IN); Nikhil Undale, Bangalore (IN)

(21) Appl. No.: 15/623,714

(22) Filed: Jun. 15, 2017

(51) Int. Cl. F01N 3/28; F01N 3/30; B01D 53/94

(52) U.S. Cl. CPC F01N 3/2803; B01D 53/94; F01N 3/30

(57) ABSTRACT

The exhaust gas system includes a catalytic converter having an inlet and an outlet, a primary exhaust pipe, an exhaust nozzle and a secondary exhaust pipe. The primary exhaust pipe includes a proximate end and a distal end. The primary exhaust pipe may be affixed to the outlet of the catalytic converter at the proximate end of the primary exhaust pipe. The secondary exhaust pipe may be coupled to the distal end of the primary exhaust pipe via the exhaust nozzle. The exhaust nozzle includes a body region which is integral to a frustoconical defined region. The body region of the exhaust nozzle may be engaged to the distal end of the primary exhaust pipe. The frustoconical defined region of the exhaust nozzle may be engaged to the secondary exhaust pipe.

### TECHNICAL FIELD

This invention relates to exhaust systems, and more particularly to an exhaust gas aspirator that cools exhaust gas prior to exiting the exhaust system.

### BACKGROUND

Environmental regulations are becoming increasingly strict with regard to engine exhaust emissions such as nitrogen oxides (NOx) and particulate matter, More stringent environmental regulations with regard to diesel engine particulate emissions has warranted the need for diesel particulate filters and/or other exhaust aftertreatment devices, such as NOx adsorbers, to be placed in the exhaust gas stream for removing or reducing harmful exhaust emissions before the exhaust is permitted to enter the atmosphere.

Typically, exhaust aftertreatment systems must initiate and control regeneration of the particulate filters, NOx adsorbers, and other exhaust treatment devices from time to time as the devices fill up with soot, NOx, or the like. Regenerating the devices removes some or all of the particulates built up on the devices by oxidizing the particles. As an example, regeneration of a particulate filter is done by increasing the temperature of the filter to a level where the soot is oxidized, e.g., above 400° C., and maintaining that temperature for a desired period of time, e.g., several minutes or longer, depending on circumstances including the size of the filter, the amount of soot on the filter, the uniformity level of the soot, etc.

The temperature of the filter is increased by increasing the temperature of the exhaust gas passing through the filter by any of various techniques known in the art. Although increasing the exhaust gas temperatures can effectuate the positive and desirable result of regenerating an exhaust aftertreatment device, exhaust gas temperatures during such regenerating events can reach extreme levels, e.g., 650° C. or more, possibly causing undesirable side effects. For example, the high exhaust temperatures required for filter regenerations usually means the exhaust leaving the tailpipe of the vehicle is much hotter than it would be during normal operation, particularly at stationary or low-speed operation. This creates a potential safety hazard with regard to the heat flux of the gases leaving the tailpipe and creating discomfort or injury to humans, animals, or plants in proximity. Moreover, extreme exhaust gas temperatures resulting from regeneration events can increase the surface temperature of exhaust train components, increase the risk of fire hazards, and cause damage to street surfaces and other objects. Additionally, extreme exhaust gas temperatures can discolor, e.g., blacken, tailpipe components, especially tailpipes with chromed outer surfaces.

Several approaches have been employed for mitigating heat from an exhaust gas stream to reduce the temperature of the exhaust as it exits the tailpipe. For example, some fire trucks are equipped with a water spray device at the exhaust outlet for exhaust cooling, but such a scheme is limited to a situation where there is a ready water supply as well as experienced firefighters. Other approaches include exhaust diffusion devices coupled to the outlet of the tailpipe. The diffusion devices are configured to cool the exhaust gas leaving the tailpipe by diluting and dispersing the exhaust gas. However, such diffusion devices are not designed to cool the exhaust gas at the tailpipe outlet, but rather to reduce the temperature of the exhaust gas at a regulated distance, e.g., six inches, away from the outlet of the tailpipe to a temperature below a regulated maximum temperature. Although some conventional diffusion devices are successful at achieving a desirable mitigation of exhaust gas heat outside of the tailpipe, e.g., at a distance away from the tailpipe outlet, such devices do not achieve cooler exhaust gas temperatures at the tailpipe outlet. Accordingly, the temperature of exhaust at the tailpipe outlet is still extremely high, which can be dangerous to people and objects near the tailpipe and cause bluing or blackening of the tailpipe itself.

To achieve cooler exhaust gas temperatures at the tailpipe outlet before, during, or after regeneration events, exhaust aspirators positioned upstream of the tailpipe outlet have been developed to entrain ambient air into the exhaust gas stream before the exhaust gas exits the tailpipe. Ambient air is entrained into the exhaust gas stream by creating an exhaust pressure drop within the aspirator that causes a vacuum effect to suck in the ambient air. The pressure drop is created by accelerating the exhaust gas through a nozzle and allowing the exhaust gas to expand upon exiting the nozzle. Typically, the pressure drop must be below a certain threshold (e.g., below 1 inch Hg) to prevent harmful levels of engine backpressure. The ambient air is mixed with the exhaust gas stream and, being cooler than the exhaust gas, reduces the temperature of the exhaust gas before it exits the tailpipe. Accordingly, the temperature of the exhaust gas is cooled within the tailpipe.

Conventional exhaust aspirators suffer from several drawbacks however. Generally, the less the ambient air and exhaust gas is mixed within the aspirator or tailpipe, the higher the radial temperature gradient, and the lower the exhaust gas temperature uniformity at the tailpipe outlet. Typically, inadequate mixing results in some portions of exhaust gas being at a generally uniform lower exhaust gas temperature at the tailpipe outlet and some concentrated pockets of exhaust gas remaining at extremely high temperatures. The concentrated pockets can be harmful and cause bluing of the tailpipe. Conventional exhaust aspirators, such as those with a single nozzle, may not adequately mix the entrained ambient air with the exhaust gas to achieve a suitable radial temperature gradient for a given exhaust pressure drop threshold. To achieve better mixing and exhaust uniformity at the aspirator outlet, some conventional exhaust aspirators are lengthened. However, longer aspirators can be more expensive to manufacture due to additional material and can occupy more valuable space within the exhaust system that could be used for other components.

Accordingly, an exhaust aspirator is desired that more adequately mixes entrained air with exhaust gas within a tailpipe to achieve a lower exhaust gas radial temperature gradient and greater exhaust gas uniformity at the tailpipe outlet.

### SUMMARY

The present disclosure provides an exhaust gas system which reduces the risk of injury from hot exhaust gases from a vehicle by achieving a lower exhaust gas radial temperature gradient and greater exhaust gas uniformity at the tailpipe outlet (or exhaust end of the secondary exhaust pipe). The exhaust gas system includes a catalytic converter having an inlet and an outlet, a primary exhaust pipe, an exhaust nozzle and a secondary exhaust pipe. The primary exhaust pipe includes a proximate end and a distal end. The primary exhaust pipe may be affixed to the outlet of the catalytic converter at the proximate end of the primary exhaust pipe. The secondary exhaust pipe or tailpipe may be coupled to the distal end of the primary exhaust pipe via the exhaust nozzle. The exhaust nozzle includes a body region which is integral to a frustoconical defined region. The body region of the exhaust nozzle may be engaged to the distal end of the primary exhaust pipe. The frustoconical defined region of the exhaust nozzle may be engaged to the secondary exhaust pipe.

It is understood that the secondary exhaust pipe or tailpipe may include a nozzle end and an exhaust end. The secondary exhaust pipe also defines plurality of apertures proximate to the nozzle end of the exhaust pipe wherein these apertures are configured to allow ambient air to mix in with the hot exhaust gas which is flowing through the exhaust nozzle. Moreover, the plurality of apertures in the secondary exhaust pipe and the frustoconical defined region of the exhaust nozzle may be configured to work together to disperse a hot exhaust gas flow from the catalytic converter into a coder ambient air flow from the plurality of apertures defined in the secondary exhaust pipe or tailpipe.

With respect to the exhaust nozzle, the frustoconical defined region includes a first end diameter and a second end diameter which is less than the first end diameter. Moreover, the body region of the exhaust nozzle includes a primary diameter which is approximately equal to the first end diameter of the frustoconical defined region. As shown in the present disclosure, the exhaust nozzle is a hollow member, and the frustoconical defined region is operatively configured to disrupt the hot exhaust flow from the catalytic converter before the hot exhaust gas flow contacts the ambient air flow which enters the exhaust system through the plurality of apertures. It is also understood that the frustoconical defined region is operatively configured to also disrupt the hot exhaust flow from the catalytic converter when (and while) the hot exhaust gas flow contacts the ambient air flow.

The frustoconical defined region may, but not necessarily, be substantially formed by a curvy surface. The frustoconical defined region may also include at least two outer recesses which are formed in the curvy surface. The two or more outer recesses may, but not necessarily, also be offset from one another. It is also understood that one outer recess may also be implemented in the frustoconical defined region.

It is also understood that, alternative to the aforementioned curvy surface with outer recesses, the frustoconical defined region may include a plurality of notches at a second end of the frustoconical defined region. It is understood that each notch in the plurality of notches may, but not necessarily, be a splayed notch where the opposite sides of each notch are not parallel to each other.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a side view of the exhaust gas system of the present disclosure.

FIG. 2 is a partial perspective view of a traditional exhaust gas system having a nozzle.

FIG. 3A is a side view of the cooling nozzle in FIG. 2.

FIG. 3B is a rear view of the cooling nozzle in FIG. 3A.

FIG. 4 is a side view of a cooling nozzle implemented in FIG. 1 in accordance with the present disclosure.

FIG. 5 is a partial side view of an exhaust gas system of the present disclosure which implements an example, non-limiting cooling nozzle implemented in FIG. 1 in accordance with the present disclosure.

FIG. 6 is a first example rear view of the cooling nozzle of the present disclosure.

FIG. 7 is a second example rear view of the cooling nozzle of the present disclosure.

FIG. 8 is a third example rear view of the cooling nozzle of the present disclosure.

FIG. 9 is a fourth example rear view of the cooling nozzle of the present disclosure.

FIG. 10 is a fifth example rear view of the coo ing nozzle of the present disclosure.

FIG. 11 is a temperature distribution plot which illustrates the concentration of hot exhaust gases at the center of the gaseous flow which exits the secondary exhaust pipe when the prior art exhaust system is implemented using the nozzle of FIGS. 3A and 3B.

FIG. 12 is a temperature distribution plot which illustrates the dispersion of exhaust gases at the center of the gaseous flow which exits the secondary exhaust pipe when the nozzle of FIG. 6 is implemented.

FIG. 13 is a temperature distribution plot which illustrates the dispersion of exhaust gases toward the sides of gaseous flow which exits the secondary exhaust pipe when the nozzle of HG, 7 is implemented.

FIG. 14 is a temperature distribution plot which illustrates the dispersion of exhaust gases toward the sides of the gaseous flow which exits the secondary exhaust pipe when the nozzle of FIG. 8 is implemented.

FIG. 15 is a temperature distribution plot which illustrates the dispersion of exhaust gases at the center of the gaseous flow which exits the secondary exhaust pipe when the nozzle of FIG. 9 is implemented.

FIG. 16 is a temperature distribution plot which illustrates the dispersion of exhaust gases at the center of the gaseous flow which exits the secondary exhaust pipe when the nozzle of FIG. 10 is implemented.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body 14 of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of,” and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

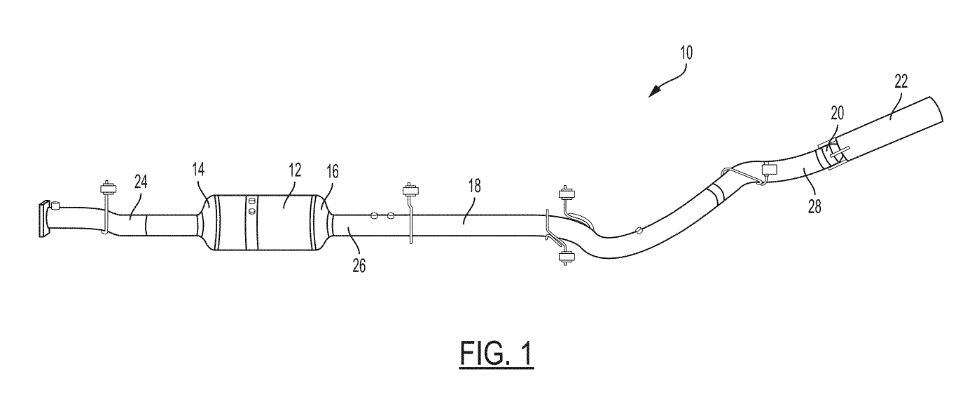

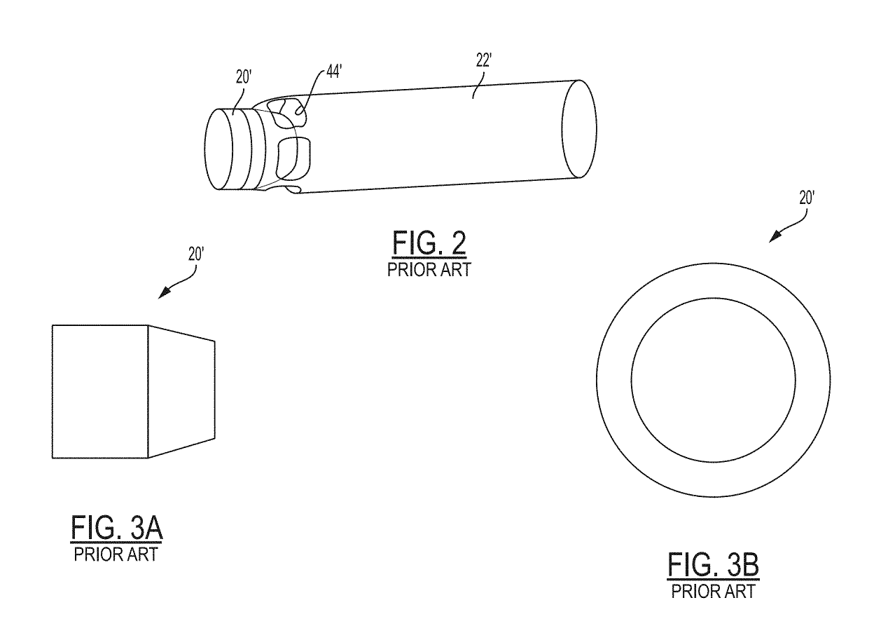

As shown in FIGS. 1, and 5-11, the present disclosure provides an exhaust gas system 10 which reduces the risk of injury from hot exhaust gases from a vehicle. The exhaust gas system 10 includes a catalytic converter 12 having an inlet 14 and an outlet 16, an intermediate exhaust pipe 24, a primary exhaust pipe 18, an exhaust nozzle 20 and a secondary exhaust pipe 22. The intermediate exhaust pipe 24 provides fluid communication from the engine (not shown) to the inlet 14 of the catalytic converter 12. The primary exhaust pipe 18 includes a proximate end 26 and a distal end 28. The primary exhaust pipe 18 may be affixed to the outlet of the catalytic converter 12 at the proximate end 26 of the primary exhaust pipe 18. The secondary exhaust pipe 22 (or tailpipe 22) may be coupled to the distal end 28 of the primary exhaust pipe 18 via the exhaust nozzle 20. The exhaust nozzle 20 includes a body region 30 which is integral to a frustoconical defined region 32. The body region 30 of the exhaust nozzle 20 may be engaged to the distal end 28 of the primary exhaust pipe 18. The frustoconical defined region 32 of the exhaust nozzle 20 may be engaged to the secondary exhaust pipe 22.

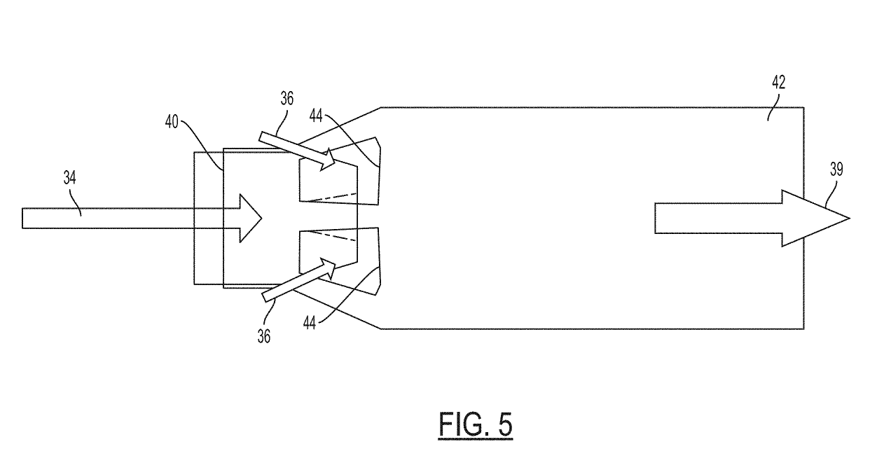

It is understood that the secondary exhaust pipe 22 (or tailpipe 22) may include a nozzle end 40 and an exhaust end 42. As shown in FIG. 5, the tailpipe 22 also defines plurality of apertures 44 proximate to the nozzle end 40 of the exhaust pipe wherein these apertures 44 are configured to allow ambient air 36 to mix in with the hot exhaust gas 34 which is flowing through the exhaust nozzle 20 such that the hot exhaust gas 34 is better distributed and mixed into the ambient air flow 36. This causes the resulting mixed gaseous flow 39 at the exhaust end 42 of the tailpipe 22 to have a lower overall temperature (approximately 400 degrees Celsius maximum). Is understood that the exhaust gas flow 34 could otherwise be as hot as 480 degrees Celsius without proper mixing as shown in the prior art data of FIG. 10 where the center region of the mixed gaseous flow has a concentration of hot exhaust gas 34 (with a temperature of 480 degrees) in the center region. Moreover, the plurality of apertures 44 in the secondary exhaust pipe 22 and the frustoconical defined region 32 of the exhaust nozzle 20 are configured to disperse a hot exhaust gas flow 34 from the catalytic converter 12 into a cooler ambient air flow 36 from the plurality of apertures 44 within the secondary exhaust pipe 22.

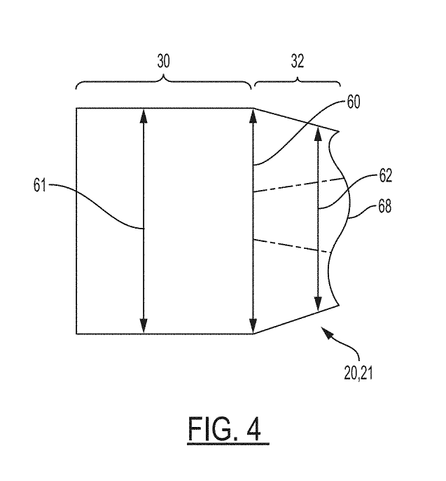

With respect to the exhaust nozzle 20 shown in FIG. 4, the frustoconical defined region 32 includes a first end diameter 60 and a second end diameter 62 which is less than the first end diameter 60 thereby resulting in a frustoconical configuration. Moreover, the body region 30 of the exhaust nozzle 20 includes a primary diameter 61 which is approximately equal to the first end diameter of the frustoconical defined region 32. As shown in the present disclosure, the exhaust nozzle 20 is a hollow member 21, and the frustoconical defined region 32 is operatively configured to disrupt the hot exhaust flow 34 from the catalytic converter 12 before the hot exhaust gas flow 34 contacts the ambient air flow 36 which enters the exhaust system 10 through the plurality of apertures 44. It is also understood that the frustoconical defined region 32 is operatively configured to also disrupt the hot exhaust flow 34 from the catalytic converter 12 when (and while) the hot exhaust gas flow 34 contacts the ambient air flow 36.

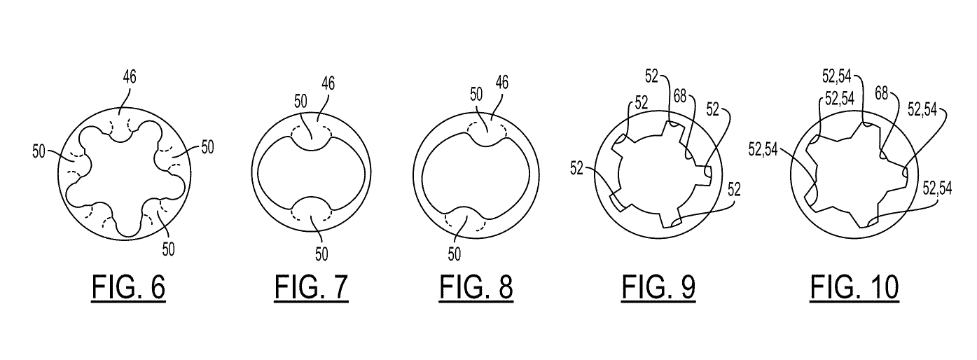

In one embodiment, the frustoconical defined region 32 may, but not necessarily, be substantially formed by a curvy surface 46. As shown in FIGS. 6-8, the frustoconical defined region 32 may also include one outer recess 50 or at least two outer recesses 50 which are formed in the curvy surface 46. The two or more outer recesses 50 may, but not necessarily, also be offset from one another as shown in FIG. 8. The frustoconical defined region 32 defines a plurality of notches 52 at a second end 68 of the frustoconical defined region 32. It is understood that each notch 52 in the plurality of notches 52 may, but not necessarily, be a splayed notch 54 where the opposite sides 56 of each notch 52 are not parallel to each other.

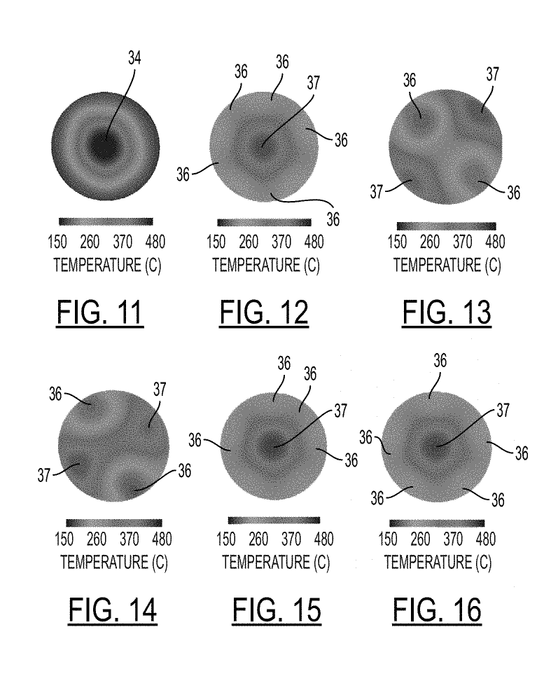

As shown in FIGS. 12, 15, and 16, temperature distribution plots are respectively provided which corresponds to nozzles shown in FIGS. 6, 9, and 10 respectively. These temperature distribution plots illustrate the dispersion of reduced temperature exhaust gases (approximately 400 degrees C.) at the center of the mixed gaseous flow 39 which exits the secondary exhaust 22 (or tailpipe 22). In contrast, the temperature distribution plot of FIG. 11 of a prior art exhaust gas system illustrates hot exhaust gases 34 concentrated at the center of the mixed gaseous flow 39 where the hot exhaust gases 34 are at approximately 480 degrees C. Accordingly, the exhaust gas system 10 of the present disclosure maintains the mixed exhaust gas flow 39 to an approximate (and safer) maximum temperature of 400 degrees Celsius.

With respect to the temperature distribution plots of FIGS. 13 and 14, these diagrams respectively correspond to cooling nozzles of FIGS. 7 and 8. As shown, the exhaust gas system of the present disclosure provides for mixed gaseous flow 39 at a reduced overall temperature which exits the secondary exhaust pipe 22 when the aforementioned nozzles are implemented. The temperature distribution plots of FIGS. 13 and 14 show the reduced temperature exhaust gases distributed toward the outer regions of the gaseous flow and furthermore, there are not any concentrations or regions where the gaseous flow has a temperature which reaches as high as 480 degrees Celsius.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. An exhaust gas system comprising:
a catalytic converter having an inlet and an outlet;
a primary exhaust pipe having a proximate end and a distal end, the primary exhaust pipe affixed to the outlet of the catalytic converter at the proximate end; and
a secondary exhaust pipe coupled to the distal end of the primary exhaust pipe via an exhaust nozzle having a body region integral to a frustoconical defined region, the body region of the exhaust nozzle being engaged to the distal end of the primary exhaust pipe, and the frustoconical defined region of the exhaust nozzle being engaged to the secondary exhaust pipe.

2. The exhaust gas system as defined in claim 1 wherein the secondary exhaust pipe includes a nozzle end and an exhaust end, the secondary exhaust pipe defining a plurality of apertures proximate to the nozzle end of the exhaust pipe.

3. The exhaust gas system as defined in claim 2 wherein the plurality of apertures in the secondary exhaust pipe and the frustoconical defined region of the exhaust nozzle are configured to disperse a hot exhaust gas flow from the catalytic converter into a cooler ambient air flow from the plurality of apertures within the secondary exhaust pipe.

4. The exhaust gas system as defined in claim 3 wherein the frustoconical defined region defines a first end diameter and a second end diameter which is less than the first end diameter.

5. The exhaust gas system as defined in claim 4 wherein the body region includes a primary diameter which is equal to the first end diameter of the frustoconical defined region.

6. The exhaust gas system as defined in claim 5 wherein the exhaust nozzle is a hollow member.

7. The exhaust gas system as defined in claim 6 wherein the plurality of apertures are operatively configured to introduce ambient air flow into the secondary exhaust pipe.

8. The exhaust gas system as defined in claim 7 wherein the frustoconical defined region is operatively configured to disrupt the hot exhaust flow from the catalytic converter before the hot exhaust gas flow contacts the ambient air flow.

9. The exhaust gas system as defined in claim 8 wherein the frustoconical defined region is operatively configured to disrupt the hot exhaust flow from the catalytic converter when the hot exhaust gas flow contacts the ambient air flow.

10. The exhaust gas system as defined in claim 9 wherein the frustoconical defined region is substantially formed from a curvy surface.

11. The exhaust gas system as defined in claim 9 wherein the frustoconical defined region defines a plurality of notches at a second end of the frustoconical defined region.

12. The exhaust gas system as defined in claim 10 wherein the frustoconical defined region defines at least two outer recesses.

13. The exhaust gas system as defined in claim 11 wherein each notch in the plurality of notches is a splayed notch.

14. The exhaust gas system as defined in claim 12 wherein the at least two outer recesses are offset from one another.

15. An exhaust gas system comprising:
a catalytic converter having an inlet and an outlet;
a primary exhaust pipe having a proximate end and a distal end, the primary exhaust pipe affixed to the outlet of the catalytic converter at the proximate end; and
a secondary exhaust pipe defining a plurality of apertures, the secondary exhaust pipe being affixed to the distal end of the primary exhaust pipe with an exhaust nozzle disposed there between, the exhaust nozzle including a frustoconical defined region operatively configured to disperse a hot exhaust gas flow as the exhaust gas flow contacts an ambient air flow from the plurality of apertures.

16. The exhaust gas system as defined in claim 15 wherein the secondary exhaust pipe includes a nozzle end and an exhaust end, the secondary exhaust pipe defining the plurality of apertures proximate to the nozzle end of the exhaust pipe.

17. The exhaust gas system as defined in claim 16 wherein the frustoconical defined region defines a plurality of notches at a second end of the frustoconical defined region.

18. The exhaust gas system as defined in claim 16 wherein the frustoconical defined region defines at least two outer recesses.

19. The exhaust gas system as defined in claim 17 wherein each notch in the plurality of notches is a splayed notch.

20. The exhaust gas system as defined in claim 18 wherein the at least two outer recesses are offset from one another.
